(19) United States
(12) Patent Application Publication
(10) Pub. No.: US 2014/0096170 A1
(43) Pub. Date: Apr. 3, 2014

(54) Systems And Methods For Communicating With Patients

(71) Applicants: William Emerson, Coventry, CT (US); Patrick Caruso, Southington, CT (US)

(72) Inventors: William Emerson, Coventry, CT (US); Patrick Caruso, Southington, CT (US)

(21) Appl. No.: 14/035,233

(22) Filed: Sep. 24, 2013

Related U.S. Application Data
(63) Continuation-in-part of application No. 13/584,893, filed on Aug. 14, 2012.
(60) Provisional application No. 61/705,817, filed on Sep. 26, 2012.
(60) Provisional application No. 61/525,037, filed on Aug. 18, 2011.

(51) Int. Cl. H04N 21/472; H04N 21/238; H04N 21/231

(52) U.S. Cl. CPC H04N 21/47202; H04N 21/231; H04N 21/238
USPC 725/98

(57) ABSTRACT

Methods and systems for communicating with a patient through a television in the patient's hospital room are disclosed. In some embodiments, the methods and systems include the following: a television signal gateway module for receiving televisions signals and encoding the signals as Ethernet-based Internet protocol signals; an application and media server including a first sub-system for storing and processing the signals and data according to instructions and generating, sending, and receiving application and media signals; and an interactive set-top-box including a second sub-system for storing and processing instructions and processing the Ethernet-based Internet protocol television signals and the application and media signals to produce television display signals, the set-top-box communicating the television display signals for display on the patient's television. In some embodiments, a whiteboard module that acts as a home page for patients as they navigate the interactive system is included in the application and media server.

### BACKGROUND

Research has shown that patient anxiety can be lessened by better communicating information about the patient's care before, during, and after their hospital stay. Currently, few, if any, technology exists that provides a comprehensive solution to enhancing communication of patient information to patients.

Known technology is outdated and based on systems for providing on-demand entertainment to lodging establishments. Such systems fail to consider the many nuances related to communicating patient information to patients before, during, and after their hospital stay.

### SUMMARY

Some embodiments of the disclosed subject matter include systems and methods for communicating with a patient through a television in the patient's hospital room. In some embodiments, a television signal comes in from either a satellite feed or a cable feed and is pushed through a box known as television signal gateway module, which encodes the signal as an Ethernet-based IP television signal. In some embodiments, the IP television signal then flows through a coax conversion router, which converts the Ethernet based IP signal to a coax signal that can travel across a coax network. Once the coax signal reaches the patient's hospital room, it is pushed through an IP modem, which converts the coax signal back to an Ethernet IP signal that is forwarded to a set-top-box (STB) and displayed on the television in the room.

Application content, including both entertainment and various patient-centric applications stored on the application and media server, is requested by the patient via a browser application module that is displayed on the television. The requests travel the same path as television signal, i.e., from the STB through the coax conversion router and IP modem. However, patient requests are directed to the application and media server to be processed. Everything other than the live television signals follows this same routing, including educational videos, movies, and games that are provided via applications stored on the application and media server. The response to a patient request is a generated Web page that is returned to the STB for display within the browser application module on the patient's television. Information stored on the application and media server is also typically provided to the STB and television via the coax conversion router and IP modem.

Some embodiments of the disclosed subject matter include an interactive system, which is used by hospitals to interact and communicate with patients and their family members through the television in the patient's hospital room. Aspects of the interactive system include an electronic whiteboard module, a sleep mode module, and a patient video monitoring module.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic diagram of methods and systems according to some embodiments of the disclosed subject matter;

FIG. 2 is a chart of a method according to some embodiments of the disclosed subject matter;

FIG. 3

FIG. 4

FIG. 5; and

FIG. 6

### DETAILED DESCRIPTION

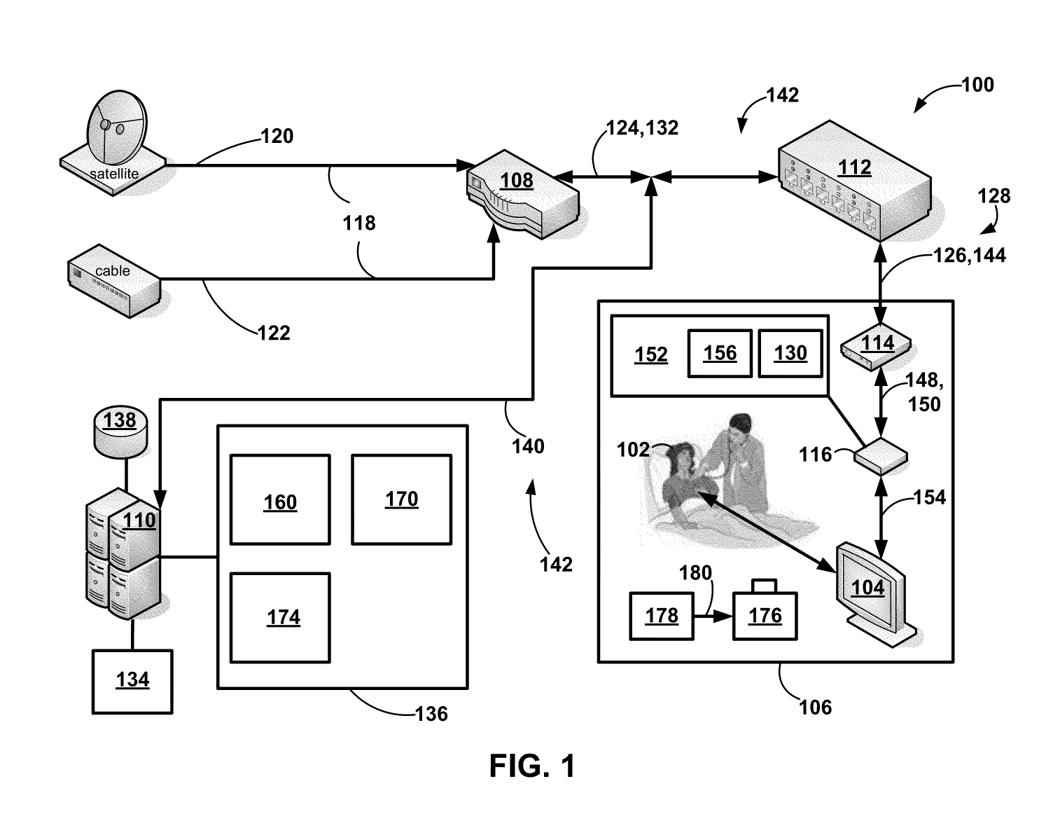

Referring again to FIG. 1, aspects of the disclosed subject matter include an interactive system 100 for communicating with a patient 102 through a television 104 in the patient's hospital room 106. System 100 includes a television signal gateway module 108, an application and media server 110, a coax conversion router 112, an Internet protocol (IP) modem 114, and an interactive STB 116, all of which cooperate with one another.

In system 100, a television signal 118 comes in from either a satellite feed 120 or a cable feed 122 and is pushed through a box known as television signal gateway module 108, which encodes the signal as an Ethernet-based IP television signal 124. In some embodiments, IP television signal 124 then flows through coax conversion router 112, which converts the Ethernet based IP signal to a coax signal 126 that can travel across a coax network 128. Once coax signal 126 reaches hospital room 106, it is pushed through IP modem 114, which converts coax signal 126 back to an Ethernet IP signal that is forwarded to STB 116 and displayed on television 104.

Application content is requested by patient 102 via a browser application module 130 that is displayed on television 104. The requests travel the same path as television signal 118, i.e., from STB 116 through coax conversion router 112 and IP modem 114. However, patient requests are directed to application and media server 110 to be processed. Everything other than the live television signals follows this same routing including educational videos, movies, and games that are provided via applications stored on application and media server 110. The response to a patient request is a generated Web page that is returned to STB 116 for display within browser application module 130 on television 104.

As mentioned above, the preexisting satellite or cable feed, i.e., television signal 118, of the hospital is routed through a piece of equipment known as television signal gateway module 108. Television signal gateway module 108 is responsible for receiving television signal 118, decoding and re-encoding the signal, if necessary, and streaming each television channel as Ethernet-based IP television signal 124. The output of television signal gateway module 108, i.e., Ethernet-based IP television signal 124, is a set of encoded streams 132, e.g., MPEG-2, MPEG-4, or similar, each representing a different television channel. Streams 132 are typically multicast using user datagram protocol (UDP), which means that a separate stream is not required for each individual television watching a particular channel but rather a single channel stream is shared by all televisions watching that channel. Each stream exposed by television signal gateway module 108 is accessed using a specific IP address and port. To access a channel, a media player application need only point to the appropriate address and port to begin to receive the television stream.

Application and media server 110 includes a first information processing sub-system 134, application modules 136, and a database 138. First information processing sub-system 134 is configured to store and process IP television signal 124, other signals, and data according to particular instructions included in application modules 136. Information processing sub-system 134 is configured to generate, send, and receive an Ethernet-based IP application and media signal 140.

Coax conversion router 112 converts Ethernet-based IP television signal 124 and the Ethernet-based IP application and media signal 140 to coax signal 126, which is configured to travel across coax network 128. For information traveling from patient's hospital room 106, e.g., application content requested by patient 102 via browser application module 130, coax conversion router 112 converts coax signal 126 to Ethernet-based IP television signal 124 and Ethernet-based IP application and media signal 140, which are configured to travel across an Ethernet network 142.

IP modem 114 is in communication with coax conversion router 112 via coaxial cable 144. For signals traveling to television 104, IP modem 114 converts coax signal 126 to an Ethernet-based IP signal 148 including IP television signal 124 and IP application and media signal 140. For signals traveling from television 104, IP modem 114 converts Ethernet-based IP signal 148 to coax signal 126 for communication across coax network 128 to coax conversion router 112. In some embodiments, IP modem 114 is external to STB 116. In some embodiments, IP modem 114 is embedded within STB 116 to further limit the hardware footprint in hospital room 106.

In some embodiments, to support the transporting of IP content over a hospital's existing coax network, coax conversion router 112 is a data over cable service interface specification (DOCSIS) router and IP modem 114 is a DOCSIS modem. DOCSIS is a telecommunications standard that supports the addition of high-speed data transfer to a television stream over an existing coax network. It is typically used by cable operators to provide Internet access alongside television over a single line. A scaled down version of DOCSIS from that used by cable providers is used to transmit both television and application content over the existing cable infrastructure of the hospital. Again, this is to prevent the need to replace the coax network at a hospital. If the hospital already has replaced their coax network with an Ethernet network or they are building a new wing and can run Ethernet to the televisions, then conversion of Ethernet-based IP signals is not necessary and coax conversion router 112 and IP modem 114 are not required.

Interactive STB 116 is in communication with IP modem 114 via an Ethernet cable 150. STB 116 includes a second information processing sub-system 152 and browser application module 130. Second information processing sub-system 152 stores and processes instructions included in browser application module 130. Browser application module 130 processes IP television signals 124 and IP application and media signal 140 to produce a television display signal 154. Browser application sub-module receives and processes instructions from patient 102 and communicates the instructions from the patient to application and media server 110. STB 116 communicates television display signal 154 for display on television 104 in patient's hospital room 106. In some embodiments, STB 116 includes a television control module 156 for recording and playback of live television and movies.

In some embodiments, STB 116 is a model FMP2700 as manufactured by Flextronics Company of Singapore running a software suite with the brand name FocusWare, which is produced by ConFocus of Norcross, Ga., on top of a Linux OS. In some embodiments, browser application module 130 includes a television browser developed by the Espial Group of Ottawa, Ontario, which is a Web kit based browser specifically developed by Espial to run in a television environment. The FocusWare software provides an abstraction layer between the hardware and applications running on STB 116. It enables the hardware acceleration required to play video streams given the minimal processing power of a typical STB. It also supplies trick-mode functionality that supports the recording and playback of live television and movies.

In use, application modules 136 of system 100 as well as a live television feed run within browser application module 130, e.g., an Internet browser such as the Espial browser, on STB 116. Videos are typically displayed inside a frame defined within the HTML-based pages of a particular application module. For example, a user selects a particular one of application modules 136 of system 100 by directing the browser of browser application module 130 to a Welcome page displayed on television 104, which lists the applications available to the user. From this page, the user can take a tour of a particular application, they can navigate to their home page, or they can watch television.

When a user watches television, they navigate to a television viewer application module, which is one of application modules 136 stored on application and media server 110 of system 100. The television viewer application module typically displays an Internet page having a number of HTML <div> statements that partition the page into various segments or frames, e.g., an alert area, an application menu, a message area that typically appears at the bottom of the page, and a television display area. The segment that contains the television feed/display has an embedded media player that has the ability to specify a URL that references the television channel to be display. When watching television, the media player points to one of the UDP based streams exposed by television signal gateway module 108 and when the connection is complete the television feed will begin to stream to the player and the television content will be displayed.

Because the media player is embedded into the Internet page displayed by the viewer application module, the other content on the page is accessible alongside the content appearing in the player. This content may not be visible at all times as the media player is typically expanded to fill the screen. However, the page is still fully functional and through the use of a remote or keyboard, the television menu may be displayed at any time. Likewise, there is a background JavaScript timer that polls the server looking for alerts and messages to be displayed to the patient. When one of these messages is received the alert area will slide down from the top of the screen above the television content/display to display the alert/message.

In some embodiments, application modules 136 of system 100 include an electronic whiteboard module 160. Electronic whiteboard module 160 acts as the Home page for patients as they navigate the interactive system. The electronic whiteboard sub-system replaces the physical whiteboard used in most hospital rooms today. Physical whiteboards are typically used to keep patients abreast of such things as their current care team, any upcoming events such as a transport to have an x-ray, and their current level of pain. The issue with physical whiteboards is that they are often not kept up-to-date as the workload of the clinical staff requires their attention on other more urgent matters.

The electronic whiteboard sub-system provides the same information as a physical whiteboard plus additional information about the patient's discharge date and the goals that must be reached for the patient to be discharged. This information is kept up-to-the-moment by automating the gathering of the information through interfaces with external systems such as the hospital's EMR, CPOE and staffing applications.

As is true of all content displayed to the patient within the interactive system, the content on the electronic whiteboard sub-system is presented in the preferred language of the patient. The patient's language is determined through information provided by the hospital's ADT or EMR system and the content of the electronic whiteboard sub-system is automatically updated.

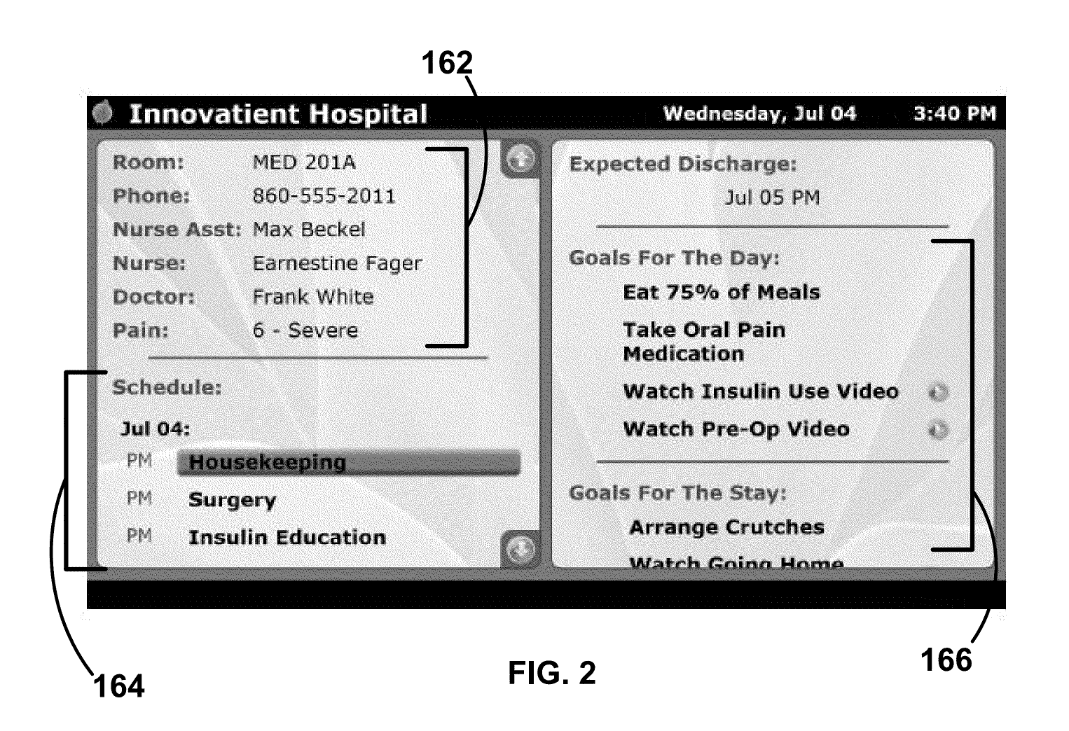

Referring now to FIG. 2, the display of the electronic whiteboard sub-system is organized into three sections along with a header that will keep the patient oriented as to where they are along with the current date and time: (1) a Room & Care Team section 162; (2) Schedule section 164; and (3) Goals section 166.

The Room & Care Team area contains information about the room the patient is in along with a list of the hospital staff and family members that make up their care team followed by the patient's current level of pain and any risk factors. Basic room information is displayed in the electronic whiteboard sub-system including the room number and the phone number where the patient can be reached. This situates the patient and provides them quick access to their contact information while in the room so that they may communicate this to family members and friends.

Following the room information, a list of the Care Team members is displayed. The selection of which Care Team members to display is based on the roles each member plays in relation to the patient. For example, the staff members acting as RNs, LPNs, and doctors assigned to the patient can be shown here as well as a patient approved Care Partner who can assist the patient and Care Team during their stay. The roles that appear on the electronic whiteboard sub-system are dynamic allowing the hospital to select the roles they would like show as well as the order in which they would like the roles to appear. Default roles are configured at the hospital level but can be overridden at the Unit level to allow for the designation of specialized roles such as Child Life Specialist for a Pediatric Unit and Diabetic Educator for a Renal Unit. Additional roles can be added by a client to cover a role not specified in the base system.

The connection between staff members and patients can be automated so that manual updating of the Care Team is not required. Information for the Care Team can come from an external Staffing Application, through an ADT feed as is often the case with physicians, and through other feeds. If adjustments to the Care Team are required the interactive system provides the means to update the members manually through the clinical side of the interactive system.

Each Care Team member can be selected in order to show their picture along with more information about the role they play for the patient. When the Care Team member is highlighted and the OK button on the remote clicked a popup Window appears showing the additional information. Hitting OK on the remote a second time closes the popup and returns the user to the electronic whiteboard sub-system.

Following the list of Care Team members the patient's current level of pain is displayed. Whenever the patient indicates their pain level, either by selecting a level from the main TV menu or from the interactive system TV Alert area, as part of an integrated pain management workflow, the pain level shown on the electronic whiteboard sub-system is updated. If the patient believes their pain level has changed from the level shown they can update it by making a selection from the main TV menu.

The Schedule area contains a list of the upcoming events for the patient. The Schedule area contains a list of the upcoming events that the patient is participating in. This can range from clinical events such as radiation treatments and physical therapy sessions to non-clinical events such as the time meals will be served or the time the Pet Therapist will be by.

The types of events that appear in the schedule are configurable so that the hospital can restrict the events to just those they wish the patient to see. Also configurable is the amount of time in the future the hospital wishes events to display. So, for example, the hospital may choose to show the events that will be occurring in the next 4 hours or perhaps over the next couple of days.

Events appear in the Schedule Area in ascending order by day and time with the events for each day grouped under a header showing the day. Only events in the future are shown. Previous events can be seen elsewhere in the interactive system. The event time that is displayed can take on one of three forms and is displayed appropriately for each event individually. It can display the actual time, for example 10:00 AM, it can show an AM/PM designation if the event is designated as a morning or afternoon event without a specific time, or it can appear with no time designated indicating the event will occur at some point within the day.

Each event in the Schedule Area can be selected in order to show more information about the event. When the event is highlighted and the OK button on the remote clicked a popup Window appears showing the additional information including a full description of the event and the location and people associated with the event. Hitting OK on the remote a second time closes the popup and returns the user to the electronic whiteboard sub-system.

The Goals area includes the patient's anticipated discharge date followed by both the patient's goals for the current day and the goals the patient must complete during their entire stay. The goals are updated to indicate when the patient has effectively completed the goal. This event driven information allows the patient to monitor their own status as it relates to their health and discharge date.

The Goal Area displays a list of the goals a patient needs to complete in order to be discharged. The goals are split into two sections, those goals that must be completed during the current day (Day Goals), and the complete list of goals that must be completed prior to the patient being discharged (Stay Goals).

When an anticipated discharge date has been specified for the patient by the hospital's ADT system, it appears at the top of the Goal Area designating the expected date and time that the patient must complete their assigned goals. If only a date has been specified, that is to say that no time was specified for discharge, then only the date is displayed. Otherwise an AM/PM designation is appended to the date to indicate the patient is to be discharged in the morning or afternoon of the date specified.

Beneath the Anticipated Discharge Date is a list of the Day Goals a patient must complete for the current day and beneath this is the list of the Stay Goals the patient must complete at some point during their stay. Both the Day and Stay Goals are assigned to the patient based on a Care Plan, which is predetermined by staff at the hospital. Each Care Plan is assigned one or more diagnosis for which the Care Plan is valid. When the ADT system used by the hospital assigns diagnoses to a patient, the patent engagement system makes a determination as to the Care Plan(s) that are to be assigned and, in turn, the goals that are then assigned to the patient. Additional goals can be added or removed manually by the staff of the hospital to accommodate special situations.

The goals in the Day Goal area have a space immediately to the left of the goal where a checkmark will appear once the goal has been completed. Goals can be marked as completed either manually by the staff of the hospital or automatically based on system events such as the completion of an educational video.

The goals in both the Day Goal and Stay Goal areas can be selected in order to show additional information about the goal. When a goal is highlighted and the OK button on the remote clicked, a popup Window appears showing a complete description of the goal and the steps that need to be taken to complete the goal. Clicking the OK button a second time closes the popup Window and returns the patient to the electronic whiteboard sub-system.

Some goals are associated with the viewing of content such as an educational video or an electronic document outlining the patient's discharge instructions. When this is the case, the popup Window that appears when the goal is selected contains an additional button that allows the patient to view the associated video or document. Once the patient has finished viewing the content, the patient can be presented with a comprehension assessment to determine if they understood the information and/or if additional information is required. Once finished, the goal is marked as complete by placing the checkmark next to the goal.

Some embodiments of the disclosed subject matter include a sleep mode module 170, which allows interactions with patients while the patient's TV appears off. Sleep mode module 170 provides functionality that allows one to remain in contact with patients at all times even while they are engaged in other activities such as watching TV or playing a video game. One way this is accomplished is via an intelligent alerting system, which delivers timely and important notifications to the patient and also allows the patient to respond to questions and menus displayed on a real-time basis. The alert content is displayed in the Alert Area that slides out from the top of the TV screen above the other content being viewed by the patient.

When a patient is not actively using the TV, for example while they are entertaining a visitor or while they are attempting to sleep, the sleep mode capability of the interactive system can be used to give the TV the appearance of being shut off while the interactive system remains active. While in sleep mode, the TV screen displays a black background giving the impression that the TV is turned off. The interactive system, however, remains active and continues to use the intelligent alerting infrastructure to display communications.

When an alert message or question is received by the TV, it is presented using the Alert Area while at the same time slightly brightening the remaining background to fully distinguish the Alert Area. When the message clears, or question answered by the patient, the Alert Area once again slides away and the TV screen blackens to its normal sleep mode appearance.

Sleep mode sub-system 170 typically includes an optional digital clock feature that can be enabled by the patient or staff of the hospital. When the digital clock has been enabled, the time of day appears on the TV when in sleep mode. This provides the patient with the current time of day and prevents the need for a separate clock in the hospital room. The digital clock also has the ability to act as an alarm clock that can be used to gently wake a patient at a pre-determined time.

Sleep mode sub-system 170, which provides sleep mode functionality to the interactive system, is accomplished through the use of a special Web page within the main Web site that serves up system content to the TV. When a patient pushes the Power button on their pillow speaker or remote, instead of powering down the TV, the patient is navigated to the “TV Sleep” page on the Web site. This page is similar in structure to other interactive system pages supporting the same alerting and menu abilities found throughout the remainder of the application.

The “TV Sleep” page is designed to present a black screen while continuing to poll for alerts. To enable the alert polling, a JavaScript timer is started that periodically polls the server using a WCF call to check to see if there is any content to be displayed in the Alert Area. When alert content is found the individual messages, surveys and pain menus are formatted and displayed to the patient. When interaction is required, the patient uses the buttons on the pillow speaker or remote (or optional keyboard and mouse) to highlight their selection and send it back to the server for processing.

The Alert Area is comprised of a named HTML <div> tag that appears on all TV pages presented within the interactive system. The <div> tag is animated so that when alert content is presented, the <div> tag slides down from the top of the TV browser Window above the other content being presented on the page. When the viewing of the alert content is complete, the <div> tag is slid back up to disappear above the viewable browser area.

While in sleep mode, whenever alert content is being displayed, JavaScript within the “TV Sleep” page is used to slightly brighten the background of the page. This distinguishes the Alert Area from the remainder of the page making the content in the Alert Area more legible. When the Alert Area is hidden, JavaScript is again used to return the page to its blackened state.

In addition to the normal interactive system alerting capability being available to the patient, the Main Menu of the TV is also available. They may use the Main Menu to exit Sleep Mode by navigating to another page on the interactive system Web site. They may also use the menu to do such things as designate their pain level at any time. To activate the menu the patient uses the Menu button on the pillow speaker or remote.

When enabled, a digital clock appears in the lower left-hand corner of the screen. The clock is displayed or hidden based on the preferences of the patient, which are maintainable through the TV. The alarm feature of the digital clock is enabled by setting one or more alarm times. When the alarm goes off, the patient can select to have a serene video played, an alarm clock sound, or to have the application navigate to live TV. Like preferences, alarm times can be maintained by the patient through the TV. Also, when the alarm goes off, if the hospital has subscribed to a weather service, basic weather information is displayed next to the current time. Following an alarm, the weather information remains on the screen until the patient navigates away from the sleep mode page.

To exit sleep mode, the patient can either hit the Power button on their pillow speaker or remote, or they can hit the Menu button as mentioned above. When the Power button is hit, the patient is navigated back to the Web page that they last viewed prior to going into sleep mode. When the Menu button is used, the patient is navigated to whatever page they select from the menu.

In some embodiments, application modules 136 of system 100 include a patient video monitoring application module 174 that provides nurses and other hospital staff with the ability to monitor patient 102 using a camera 176 in patient's hospital room 106. Patient video monitoring module 174 includes a motion sensor 178 positioned in patient's hospital room 106 for sensing when patient 102 moves. Camera 176 is typically a network enable camera that provides two way communications over a standard IP network. In some embodiments, motion sensor 178 is embedded in camera 176. Camera 176 is activated either manually, according to a schedule, automatically in response to a signal 180 from motion sensor 178, or a combination thereof. In some embodiments, patient video monitoring application module 174 uses digital cameras to stream video and audio to endpoints over an IP (Internet Protocol) based network to monitor patients using a live video feed, record videos on request or as part of a recurring schedule, take snapshots (still images) of the patient on both an ad hoc and scheduled basis, and provide video chat capability with staff and family members.

The primary view port of the patient video monitoring sub-system for both live and recorded videos is the care conductor application, which is used by nurses and other hospital staff to view and maintain patient information. Given the proper security access, staff members use the care conductor application to connect to a camera and begin a live feed. This provides hospital staff with the ability to remotely monitor patient activity. In addition to this ad hoc type of viewing, a live feed can also be activated based on motion and/or sound within a room.

The care conductor application is also used to record videos and to take snapshots of patients. Both recordings and snapshots can be taken on an ad hoc basis, e.g., as a one-time request, or they can be scheduled so that the recordings/snapshots are taken on a recurring basis. The ability to schedule recurring records/snapshots allows a hospital to capture a visual record of the periodic activities required for many patients. For example, often when a patient is immobilized, hospital staff is required to turn the patient every four hours to prevent bed soars from occurring. A snapshot schedule can be established to capture an image every four hours documenting the fact that the turning did occur. All video recordings and snapshots can be forwarded to the electronic health record (EHR) of the patient to become a permanent part of their medical record.

In some embodiments, the cameras are also used as part of a video chat capability that allows video conversations between patients and staff members and/or patients and family members. In a chat scenario, the camera and TV in the patient room combine to provide one half of the chat session with the camera providing the video and audio feed and the TV acting as the view port of the inbound feed from the staff or family member. As is implied in a “chat” session, the cameras involved must support an audio capability along with the video. This must be taken into consideration when deploying the patient video monitoring sub-system as not all cameras support audio.

The cameras used in the patient video monitoring sub-system are IP based cameras that have the ability to stream video across any IP network including a standard Ethernet network, Wi-Fi (camera dependent), fiber or a COAX network, all of which are supported by the interactive system TV infrastructure. A variety of cameras are available in order to accommodate different monitoring requirements. For example, some camera models have PTZ (pan-tilt-zoom) capabilities in order to cover a large area, some are geared toward low-light scenarios, some have audio capabilities and some have the ability to focus while others have an automatic focus feature. Different models of cameras can be used within a single implementation to cover any variations in need.

Security is built into the patient video monitoring sub-system infrastructure to prevent access to the cameras from outside system applications. All cameras are configured to require a user id and password before starting a video feed or allowing remote configuration of the camera to take place. These credentials are known only to the system infrastructure and are encrypted and passed when first accessing the camera. In addition, the patient must give their permission for the cameras to be used by setting a value accessible only though the TV set in their hospital room.

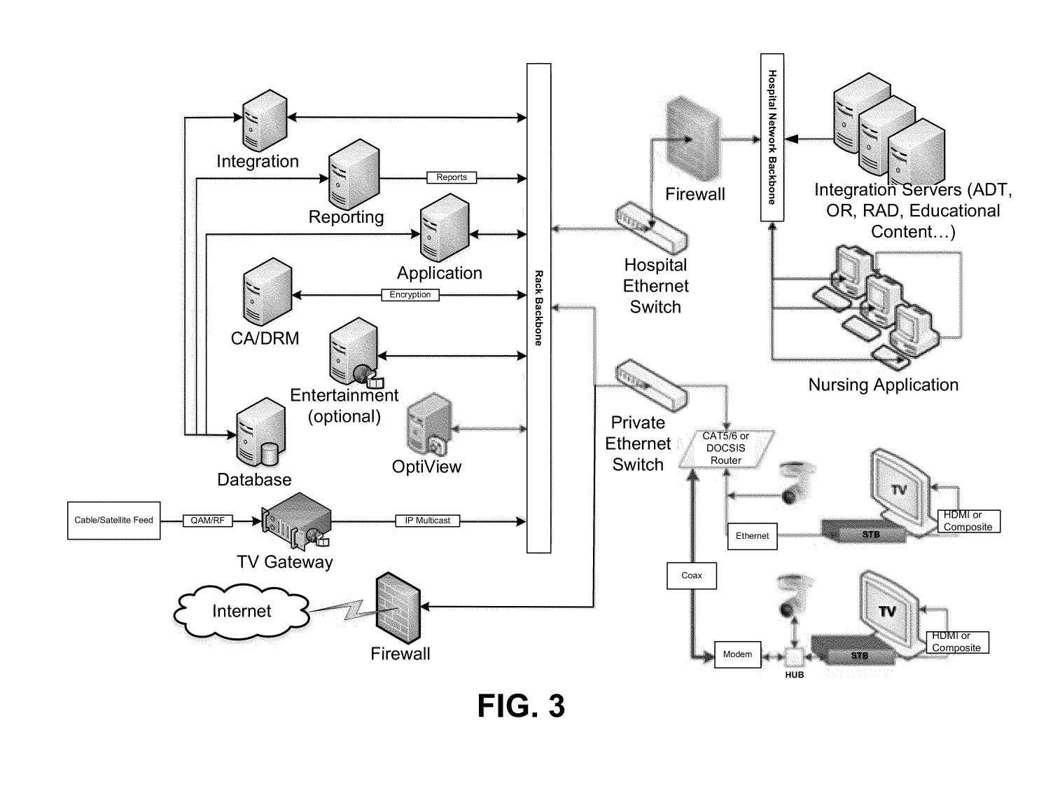

Referring now to FIG. 3, which includes a diagram of the primary pieces of the overall system architecture that apply to the patient video monitoring sub-system. The patient video monitoring sub-system server resides alongside the other interactive system servers and is responsible for the management of video recordings and snapshots. The cameras (appearing in the lower right-hand area of FIG. 3) are distributed to the patient rooms within the hospital. They are connected to the same IP based network as the system set top boxes (STB) and can utilize either a COAX or Ethernet based cabling infrastructure. The video is streamed directly from the cameras to the workstations (shown in the upper right area of FIG. 3) of the staff members monitoring the patient. Due to the direct connection between camera and viewing endpoint, the patient video monitoring sub-system server only comes into play when recording a video or snapshot at which time it makes a separate direct connection to the camera. A maximum of 10 concurrent connections to a camera can be made.

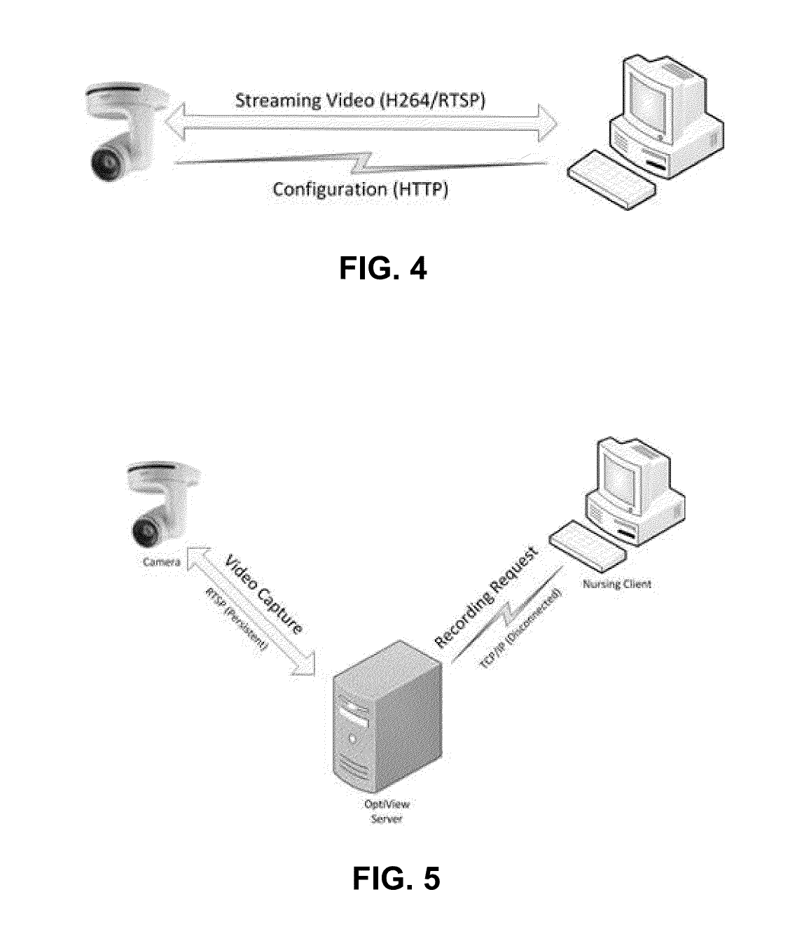

Referring now to FIG. 4, there are two basic methods used when communicating with a camera. The first uses RTSP to stream video to a client. RTSP is a standard method for handling streaming resources and provides both a secure and efficient method for video display. The h.264/MP4 codec is used when streaming video over RTSP allowing for the compression of the video stream thus minimizing the bandwidth required by a patient video monitoring sub-system camera.

The second communication method uses standard HTTP protocols and is used to retrieve information about the camera prior to starting a video stream and to update the camera's configuration during administration. HTTP communications uses port 80 when communicating with the camera (443 if using SSL) and RTSP communicates using port 554. These ports must be opened in any firewalls that reside between the camera and the clients in order for the patient video monitoring sub-system to work properly.

Referring now to FIG. 5, all video recording occurs on the patient video monitoring sub-system server. This includes the ad hoc recordings that are started and stopped on the client. When a recording is requested, the client sends a command to the patient video monitoring sub-system server indicating the camera to record and, optionally, the duration for which the recording should take place. The patient video monitoring sub-system server then establishes its own connection to the camera and starts the recording.

When a duration value is passed in the initial client recording request the patient video monitoring sub-system server will record for the period of time specified. If a duration value is not specified, the recording will continue until told to stop by the client. A “keep-alive” message is sent from the client periodically indicating to the server that the client still wishes the recording to continue. Should the client stop sending this periodic message, the server will end the recording making the assumption that an issue has occurred on the client prior to the client indicating that the video should be stopped. All video is written in the MP4 format.

Recordings can be requested on a recurring basis by starting a camera recording service. When a recording service is created the user specifies the frequency with which recordings should take place, the duration of each recording and the date and time when the recordings should stop. Scheduled recordings follow the patient from one hospital room to the next and need to be stopped manually if they are no longer required.

Unlike recordings, snapshots occur not on the patient video monitoring sub-system server, but on the client watching a video stream. The patient video monitoring sub-system server does, however, come into play when the snapshot is being saved to the patient's record. When a snapshot is being saved it is forwarded by the client to the patient video monitoring sub-system server whose responsibility it is to determine the location where the snapshot is to be written and to write the snapshot to disk. Snapshots are written to disk in the JPEG format.

A user can take a snapshot at any time by clicking the snapshot button on the patient video control of the patient profile page. When a snapshot is taken the user is presented with a popup Window where they can view the snapshot image, make a determination whether or not they would like to save the snapshot to the patient's record and, alternatively, print or email the snapshot. When they choose to save the snapshot to the patient's record, a request is made to the patient video monitoring sub-system server passing along the snapshot and telling the server to save the image to disk.

All of the patient video monitoring sub-system cameras support a credential based authentication scheme. Anonymous access is disabled when the camera is initially configured and a user id and password established that is known only to the interactive system infrastructure. When a request is made for a video feed by a system client, the user id and password are encrypted and forwarded to the camera as part of the request. Only when the camera receives the proper credentials will it start the video feed. This discourages attempts from outside the system application to connect to the cameras directly in order to view patients.

Access to the patient video monitoring sub-system viewer within the care conductor application is restricted using the interactive system authorization infrastructure, which is used to restrict access to all functionality within the system application. Staff members attempting to use a camera to monitor a patient must be assigned the appropriate privileges in order to access the page on which camera video is displayed. If a user has not been granted sufficient privileges, they will be prevented from accessing the page and, in fact, will not be shown the icons used to navigate to camera functionality.

Also, video monitoring must be approved by the patient prior to a video feed being opened. The patient preference infrastructure of the system application is used to provide this approval. A special preference, called the video monitoring preference, has been established to allow the patient to specify whether they wish to allow or deny use of the camera during their hospital visit. The video monitoring preference can only be set by the patient through the TV set in their hospital room. Access to this preference is viewable within the care conductor application used by hospital staff however its value cannot be changed. When an attempt is made to start a video feed for a patient that has elected to turn Video Monitoring off the user is notified of this and the video is not started. The default value of the Video Monitoring preference is “OFF” and therefore an action must be taken by the patient to enable it.

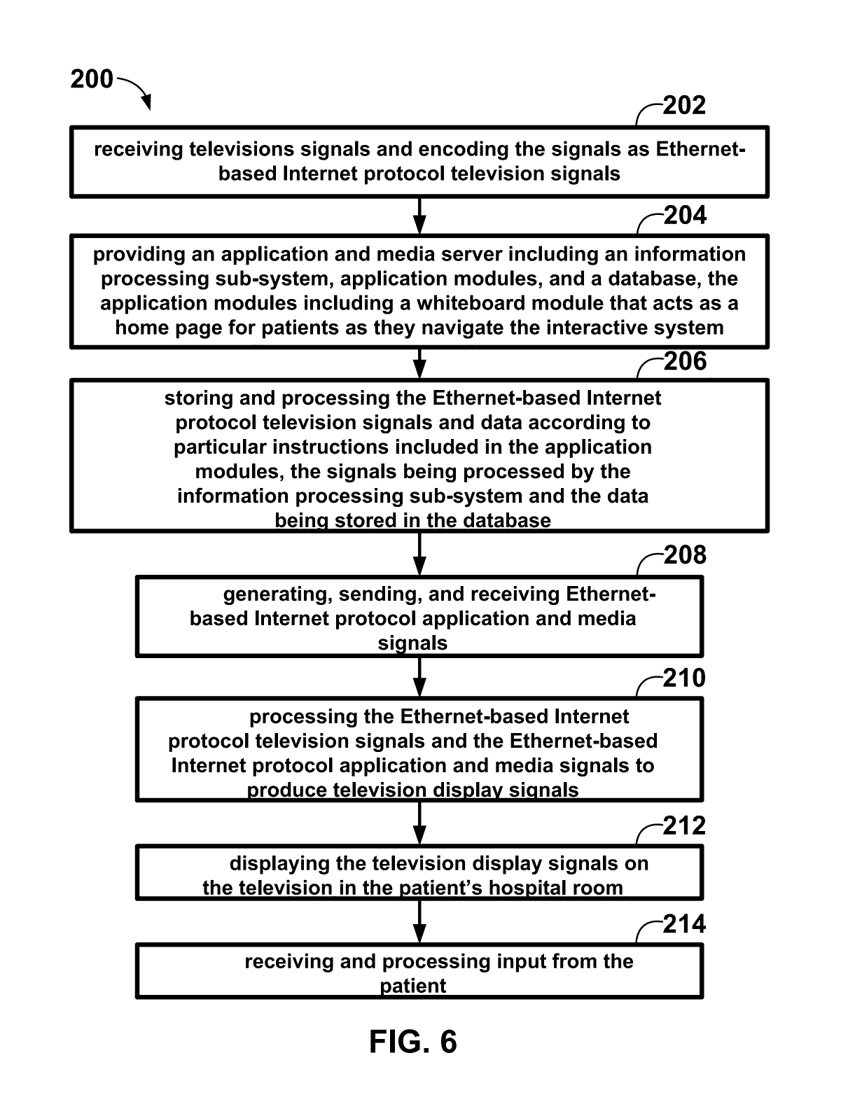

Referring now to FIG. 6, some embodiments include a method 200 for interactively communicating with a patient through a television in the patient's hospital room. At 202, televisions signals are received and encoded as Ethernet-based IP television signals. At 204, an application and media server including an information processing sub-system, application modules, and a database is provided. In some embodiments, the application modules include a whiteboard module that acts as a home page for patients as they navigate the interactive system. At 206, in accordance with particular instructions included in the application modules, data is stored in a database and the information processing sub-system processes the Ethernet-based IP television signals. At 208, Ethernet-based IP application and media signals are generated, sent, and received. At 210, the Ethernet-based IP television signals and the Ethernet-based IP application and media signals are processed to produce television display signals. At 212, the television display signals are displayed on the television in the patient's hospital room. At 214, input from the patient is received and processed.

Systems and applications according to the disclosed subject matter offer advantages over known systems. The interactive system's electronic whiteboard module replaces the physical whiteboard in the patient's hospital room providing up-to-the-moment information to the patient to aide in their healing. It provides the patient with the knowledge they need to make decisions on their care while freeing up staff to focus on other, more urgent matters than keeping the whiteboard up to date. It identifies the patient's location and contact information, the staff members that make up their Care Team, it alerts them as to upcoming events, and it provides information as to what they need to accomplish in order for them to be discharged.

The sleep mode module, which provides a sleep mode capability to the interactive system, allows constant communication with a patient even while the TV is not in use. Although the TV appears off, the Alert Area and interactive system Main Menu are still both active and can be used as they are on other interactive system Web pages. The digital clock feature provides the patient with the time of day and the ability to set a wakeup alarm while in sleep mode.

The patient video monitoring module within the interactive system provides the means to remotely monitor patients while they are in the hospital room. The video and snapshot recording capability of patient video monitoring module allows for the documenting of a patient's activities and progress to their electronic health record. Security measures have been employed to prevent access to the camera from outside the interactive system applications and to require patient permission before access is enabled from within system.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. An interactive system for communicating with a patient through a television in the patient's hospital room, said system comprising:
a television signal gateway module for receiving a television signal and encoding said signal as an Ethernet-based Internet protocol television signal;
an application and media server including a first information processing sub-system and application modules, said first information processing sub-system being configured to store and process said signal and data according to particular instructions included in said application modules, said information processing sub-system being configured to generate, send, and receive an Ethernet-based Internet protocol application and media signal, said application modules including a whiteboard module that acts as a home page for patients as they navigate the interactive system; and
an interactive set-top-box including a second information processing sub-system and a browser application module, said second information processing sub-system being configured to store and process instructions included in said browser application module, said browser application module being configured to process said Ethernet-based Internet protocol television signal and said Ethernet-based Internet protocol application and media signal to produce a television display signal, said browser application module being configured to receive and process instructions from the patient and communicate said instructions from the patient to said application and media server, said set-top-box being configured to communicate said television display signal for display on the television in the patient's hospital room; and [symbol]
.

2. The system according to claim 1, further comprising:
a coax conversion router for converting said Ethernet-based Internet protocol television signal and said Ethernet-based Internet protocol application and media signal to a coax signal, and for converting said coax signal to said Ethernet-based Internet protocol television signal and said Ethernet-based Internet protocol application and media signal; and
an Internet protocol modem in communication with said coax conversion router and said set-top-box, said Internet protocol modem being configured to convert said coax signal to an Ethernet-based Internet protocol signal for communication to said set-top-box and configured to convert Ethernet-based Internet protocol signal to said coax signal for communication across said coax network to said coax conversion router.

3. The system according to claim 1, wherein said whiteboard module includes a Room & Care Team section, a Schedule section, and a Goals section.

4. The system according to claim 1, wherein said application modules include a patient video monitoring application module, said patient video monitoring module comprising:
a motion sensor positioned in the patient's room for sensing when the patient moves; and
a network enable camera configured to provide two way communications over a standard Internet protocol network, wherein said camera is activated either manually, according to a schedule, automatically in response to a signal from said motion sensor, or a combination thereof; and
wherein a patient must give their permission for the camera to be activated by setting a value accessible only though the television in their hospital room.

5. The system according to claim 1, wherein said application modules include a sleep mode module configured to display a black background on the patient's television while allowing messages to be displayed on the television.

6. The system according to claim 1, wherein said set-top-box includes a television control module for recording and playback of live television and movies.

7. A method for interactively communicating with a patient through a television in the patient's hospital room, said method comprising:
receiving televisions signals and encoding said signals as Ethernet-based Internet protocol television signals;
providing an application and media server including an information processing sub-system, application modules including a whiteboard module that acts as a home page for patients as they navigate the interactive system, and a database;
storing and processing said Ethernet-based Internet protocol television signals and data according to particular instructions included in said application modules, said signals being processed by said information processing sub-system and said data being stored in said database;
generating, sending, and receiving Ethernet-based Internet protocol application and media signals; and
processing said Ethernet-based Internet protocol television signals and said Ethernet-based Internet protocol application and media signals to produce television display signals; and
displaying said television display signals on the television in the patient's hospital room.

8. The method according to claim 7, further comprising receiving and processing input from the patient.

9. The system according to claim 7, wherein said whiteboard module includes a Room & Care Team section, a Schedule section, and a Goals section.

10. The method according to claim 7, further comprising:
converting said Ethernet-based Internet protocol television signals and said Ethernet-based Internet protocol application and media signals to coax signals, which are configured to travel across a coax network;
converting said coax signals to said Ethernet-based Internet protocol television signals and said Ethernet-based Internet protocol application and media signals, which are configured to travel across an Ethernet network;
converting said coax signals to Ethernet-based Internet protocol signals; and
converting Ethernet-based Internet protocol signals to said coax signals for communication across said coax network.

11. The method according to claim 7, wherein said application modules include a sleep mode module configured to display a black background on the patient's television while allowing messages to be displayed on the television.

12. The method according to claim 7, wherein said application modules include a patient video monitoring application module, said patient video monitoring module having instructions comprising:
sensing in a patient's room when the patient moves; and
activating either manually, according to a schedule, automatically in response to sensing when the patient moves, or a combination thereof, a network enable camera configured to provide two way communications over a standard Internet protocol network;
wherein a patient must give their permission for the camera to be activated by setting a value accessible only though the television in their hospital room.

13. An interactive system for communicating with a patient through a television in the patient's hospital room, said system comprising:
a television signal gateway module for receiving televisions signals and encoding said signals as Ethernet-based Internet protocol television signals;
an application and media server including a first information processing sub-system, application modules, and a database, said first information processing sub-system being configured to store and process said signals and data according to particular instructions included in said application modules, said information processing sub-system being configured to generate, send, and receive Ethernet-based Internet protocol application and media signals, said application modules including a whiteboard module that acts as a home page for patients as they navigate the interactive system;
a coax conversion router for converting said Ethernet-based Internet protocol television signals and said Ethernet-based Internet protocol application and media signals to coax signals, which are configured to travel across a coax network, and for converting said coax signals to said Ethernet-based Internet protocol television signals and said Ethernet-based Internet protocol application and media signals, which are configured to travel across an Ethernet network;
an Internet protocol modem in communication with said coax conversion router via a coaxial cable, said Internet protocol modem being configured to convert said coax signals to Ethernet-based Internet protocol signals including said Ethernet-based Internet protocol television signals and said Ethernet-based Internet protocol application and media signals and configured to convert Ethernet-based Internet protocol signals to said coax signals for communication across said coax network to said coax conversion router; and
an interactive set-top-box in communication with said Internet protocol modem via an Ethernet cable, said interactive set-top-box including a second information processing sub-system and a browser application module, said second information processing sub-system being configured to store and process instructions included in said browser application module, said browser application module being configured to process said Ethernet-based Internet protocol television signals and said Ethernet-based Internet protocol application and media signals to produce television display signals, said browser application module being configured to receive and process instructions from the patient and communicate said instructions from the patient to said application and media server, said set-top-box being configured to communicate said television display signals for display on the television in the patient's hospital room.

14. The system according to claim 13, wherein said whiteboard module includes a Room & Care Team section, a Schedule section, and a Goals section.

15. The system according to claim 13, wherein said application modules include a sleep mode module configured to display a black background on the patient's television while allowing messages to be displayed on the television.

16. The system according to claim 13, wherein said application modules include a patient video monitoring application module, said patient video monitoring module comprising:
a motion sensor positioned in the patient's room for sensing when the patient moves; and
a network enable camera configured to provide two way communications over a standard Internet protocol network, wherein said camera is activated either manually, according to a schedule, automatically in response to a signal from said motion sensor, or a combination thereof
wherein a patient must give their permission for the camera to be activated by setting a value accessible only though the television in their hospital room.
